(19) United States
(12) Patent Application Publication
(10) Pub. No.: US 2026/0237913 A1
(43) Pub. Date: Aug. 13, 2026

(54) IMPROVED STEERING OF ANTENNA BEAM POINTING DIRECTIONS

(71) Applicant: Telefonaktiebolaget LM Ericsson (publ), Stockholm (SE)

(72) Inventors: Sam AGNEESSENS, Torslanda (SE); Eddie THELANDERSSON, Västra Frölunda (SE); Oskar TALCOTH, Göteborg (SE); Lars MANHOLM, Göteborg (SE)

(21) Appl. No.: 19/153,521

(22) PCT Filed: Feb. 6, 2023
(86) PCT No.: PCT/SE2023/050099

§ 371 Date: Aug. 4, 2025

(51) Int. Cl. H01Q 19/19; H01Q 1/12; H01Q 3/08

(52) U.S. Cl. CPC H01Q 19/193; H01Q 1/1257; H01Q 3/08

(57) ABSTRACT

The present disclosure relates to an antenna arrangement (102) comprising an antenna device (103) adapted for a main beam (104), and a control arrangement (105, 105′), where the control arrangement (105, 105′) is releasably attachable to the antenna device (103). The antenna device (103) comprises steering means (106) for steering a pointing direction (D) of the main beam (104), and operating means (107) adapted to operate the steering means (106). Furthermore, the control arrangement (105, 105′) comprises a control assembly (108, 108′) adapted to engage the operating means (107) when the control arrangement (105, 105′) is attached to the antenna device (103), such that the control assembly (108, 108′) is to control the steering means (106) via the operating means (107).

### TECHNICAL FIELD

The present disclosure relates to an antenna arrangement comprising an antenna device adapted for a main beam, where the antenna device comprises steering means for steering a pointing direction of the main beam.

### BACKGROUND

Microwave links are an essential part of many telecom networks, being considered as a good option thanks to advantages such as fast time to market, low installation cost, large capacities, and reliability. For most links, there are performance limitations such as signal fades, which for example can be caused by rain, multipath, and mast sway. The latter can, for example, be induced by wind, earthquakes or by thermal deformation, which apart from causing events with deep fading, might induce rapid fluctuations in the received signal power. Fixed point-to-point links rely on a high system gain between transmitter and receiver to overcome the regular path loss due to spherical spreading of the waves and to overcome signal fades in the channel.

At mm Wave frequencies, in particular E-band (60 GHz to 90 GHz), W-band (75 to 110 GHz) and D-band (110 GHz to 170 GHz), the impact of rain and path loss, spherical wave spreading, becomes more severe than at traditional frequency bands at lower frequencies. Furthermore, a power amplifier's ability to generate high output power is limited. To achieve high system gain, for example large high gain antennas can be used.

High gain antennas have very narrow main beams, for example approximately 0.5 degrees half-power beamwidth for a 60 cm 50 dBi E-band antenna. This makes the link extremely sensitive to any kind of antenna misalignment or movement of the mounting structures, which causes fading dips that temporarily reduce the link gain and hence the link's capability to sustain a certain communication rate, or fade margin necessary to achieve the targeted availability. Such a movement can be induced by wind, thermal deformation, or any other source of vibrations. The fading dips caused by misalignment can be very steep due to the pattern of the antenna, There are different ways to handle misalignment, for example using antennas with beamsteering capabilities where antennas for point-to-point links typically are reflector based, due to their high gain, good efficiency, low cost, and low sidelobe characteristic. Such an antenna can be a mast sway compensating steerable antenna which has a mechanism that enables the beam of the antenna to be steered and point towards the far end of the link while the mast or antenna moves, without having to realign the antenna. In addition to the antenna itself, it also needs electronics, movement sensors and/or connection to the radio for information on the received signal strength, and actuators in case the steering is achieved by a mechanical method, for example by moving a reflector feeder, or a (sub-)reflector.

Steerable antennas with high gain for wireless backhauling are expensive compared to standard antennas without beamsteering capability. It's not economical to install steerable antenna at all sites from the start and risk it not being used, while swapping a regular antenna on a link to a steerable antenna means that the old antenna has to be discarded or stored somewhere and a new antenna has to be mounted. This of course induces extra work and cost.

It is therefore desired to provide improved means for handling misalignment of a radio link antenna.

### SUMMARY

The object of the present disclosure is to provide improved means for alignment of a radio link antenna.

This object is obtained by means of an antenna arrangement comprising an antenna device adapted for a main beam, and a control arrangement that is releasably attachable to the antenna device. The antenna device comprises steering means for steering a pointing direction of the main beam, and operating means adapted to operate the steering means. Furthermore, the control arrangement comprises a control assembly adapted to engage the operating means when the control arrangement is attached to the antenna device, such that the control assembly is enabled to control the steering means via the operating means.

This means that a releasably attachable control arrangement is used to control the steering means, such that the control arrangement only is attached when needed. This provides versatility and the possibility to choose if the antenna device should be steerable or not. This provides easily upgradable functionality where beamsteering antennas can be made in high volume, which reduces the cost per unit. This is enables since the beamsteering functionality is in the removeable and exchangeable control arrangement that easily can be replaced by a newer or upgraded unit, without having to replace the entire antenna.

According to some aspects, the control arrangement comprises means adapted to determine movement data. In this way, the control arrangement is adapted to collect data that can be used to determine if beemsteering is needed.

According to some aspects, the means adapted to determine movement data comprises at least one of an accelerometer and a gyroscope. In this way, standard components can be used to collect data related to if beemsteering is needed.

According to some aspects, the control arrangement comprises a communication device that is adapted to communicate the determined movement data. In this way, the data in questions can communicated to other units.

According to some aspects, the control arrangement is an adjusting control arrangement that comprises an adjusting control assembly that is adapted to inflict controlled movements to the steering means via the operating means. Each controlled movement corresponds to a certain pointing direction such that the pointing direction is steerable by means of the control assembly.

This means that the control arrangement actively can change a beam pointing direction by engaging and co-operating with parts comprised in the antenna device.

According to some aspects, the adjusting control assembly is adapted to engage the operating means by means of an adjustable mechanical interface that comprises at least one of
a pinion rack
a gear wheel
a push rod
an axis
a threaded rod
a chain
a belt.

There thus exists many ways to provide a suitable adjustable mechanical interface that is adapted to engage the operating means According to some aspects, the antenna device comprises a reflector dish and the steering means comprises a reflector feed and a waveguide part, connected between the feed and a waveguide joint. The operating means is in the form of an operating rod that is mechanically connected to the waveguide part, such that the position of the operating rod determines the position of the waveguide part and the reflector feed. According to some further aspects, the adjusting control assembly is adapted to move the operating rod such that the reflector feed is moved and the pointing direction is steered in a desired direction.

This means that the operating rod can be moved my means of the adjusting control assembly such that a beam pointing direction can be obtained.

According to some aspects, the adjusting control assembly comprises a motor device that is adapted to move the operating rod via the adjustable mechanical interface. In this way an automatic steering of the beam pointing direction is enabled.

According to some aspects, the motor device is adapted to steer the pointing direction of the main beam either as a compensation for slow changes due to temperature variations, as compensation for fast changes due to wind and/or vibrations, or as a compensation for an induced permanent misalignment. This means that the present disclosure is applicable for many types of disturbances.

According to some aspects, the antenna arrangement further comprises a control unit that is adapted to control the adjusting control assembly. This enables a reliable control of the adjusting control assembly. According to some aspects, the control unit is adapted to control the adjusting control assembly in dependence of determined movement data. According to some further aspects, the control unit is adapted to control the adjusting control assembly in dependence of determined properties for a received signal, received signal properties, including at least one of received signal strength, Signal to Interference plus Noise Ratio, SINR, Signal to Noise Ratio, SNR, Mean Square Error, MSE, and throughput, errors including at least on of Bitrate Error, BER and Block Error Rate, BLER.

This means that the control unit can be adapted to control the adjusting control assembly in dependence of either one of determined movement data and determined data related to received signal properties.

In this context it is important determine whether the signal properties relate to mast sway or other causes. Therefore, according to some aspects, the control unit is adapted to determine if certain received signal properties relate to mast sway or not by means of analysis of periodic variations of the received signal properties with different time scales associated with different types of sway. For example, for received signal strength, i.e., fading due to rain lowers the received signal strength but should not be interpreted as mast sway. If the signal properties for example reflect heavy precipitation, beemsteering may not lead to an increased signal level.

According to some aspects, the control arrangement is a fixed control arrangement that comprises a fixed control assembly adapted to engage the operating means by means of a fixed mechanical interface that is adapted to control the steering means to assume and maintain a fixed pointing direction of the main beam. This means that the control arrangement is adapted to engage the operating means in such a way that the steering means sets and maintains a certain fixed pointing direction. This can for example be suitable as a first step, during an initial deployment of the antenna arrangement.

According to some aspects, the antenna device comprises a type identification. This can be useful to determine how to fine tune the antenna device, for example if the radiation pattern is known. One example is an RFID tag in the antenna device and an RFID reader in the control arrangement.

Moreover, this object is also obtained by means of radio link nodes, radio link arrangements and methods associated with the above advantages.

### BRIEF DESCRIPTION OF THE DRAWINGS

The present disclosure will now be described more in detail with reference to the appended drawings, where:

FIG. 1 shows a schematic view of point-to-point radio link arrangements;

FIG. 2 shows a schematic cut-open side view of an antenna arrangement with detached control arrangements;

FIG. 3 shows a schematic cut-open side view of an antenna arrangement with mounted control arrangement;

FIG. 4 illustrates a control unit;

FIG. 5 shows a computer program product; and

FIG. 6 illustrates methods according to the present disclosure.

### DETAILED DESCRIPTION

Aspects of the present disclosure will now be described more fully with reference to the accompanying drawings. The different devices, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

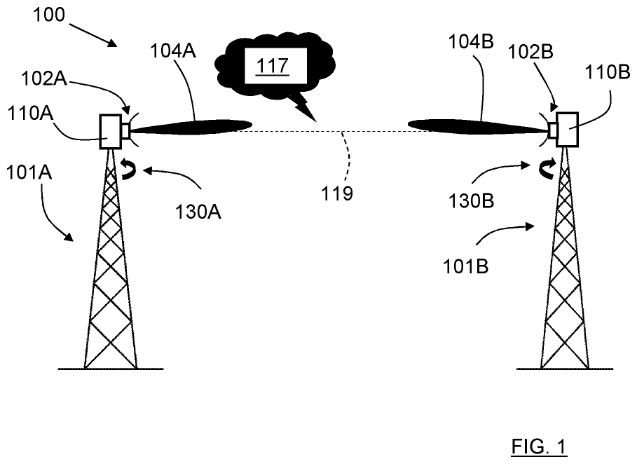

With reference to FIG. 1, there is a point-to-point radio link arrangement 100 comprising a first link node 101A and a second link node 101B which are arranged to communicate with each other via a communication link 119. The first link node 101A comprises a first transceiver (TRX) arrangement 110A and a first radio link antenna arrangement 102A, being adapted for a first main beam 104A, and the second link node 101B comprises a second TRX 110B and a second radio link antenna arrangement 102B, being adapted for a second main beam 104B. The communication link 119 may be disturbed, for example due to weather events 117 such as wind, heat and cold, where mast movement 130A, 130B may result. Mast movement 130A, 130B may of course result from many other reasons, for example vibrations du to traffic and natural occurrences such as earthquakes. The TRXs 110A, 110B can according to some aspects be regarded as radio units.

In order to counteract this and to maintain the communication link 119, it is possible to employ beamsteering antennas. These are modifications of standard antennas, in this example reflector antennas, that achieve steering of the respective main beam 104A, 104B by changing the configuration of the antenna system. This is for example achieved by moving or rotating the feeder antenna, by changing the pattern of the feeder antenna, focal plane array, or by modifying how the radiation coming from the feeder antenna is collimated by the reflector system. For example, by moving the reflector or a sub-reflector, or by modifying its shape.

As mentioned initially, steerable antennas, or beamsteering antennas, with high gain for wireless backhauling are expensive compared to standard antennas without beamsteering capability. It's not economical to install steerable antenna at all sites from the start and risk it not being used, while swapping a regular antenna on a link to a steerable antenna means that the old antenna has to be discarded or stored somewhere and a new antenna has to be mounted. This of course induces extra work and cost.

In order to provide a cost-effective solution, an antenna arrangement is disclosed in the following. The antenna arrangement can for example be constituted by a radio link antenna arrangement 102A, 102B according to the above.

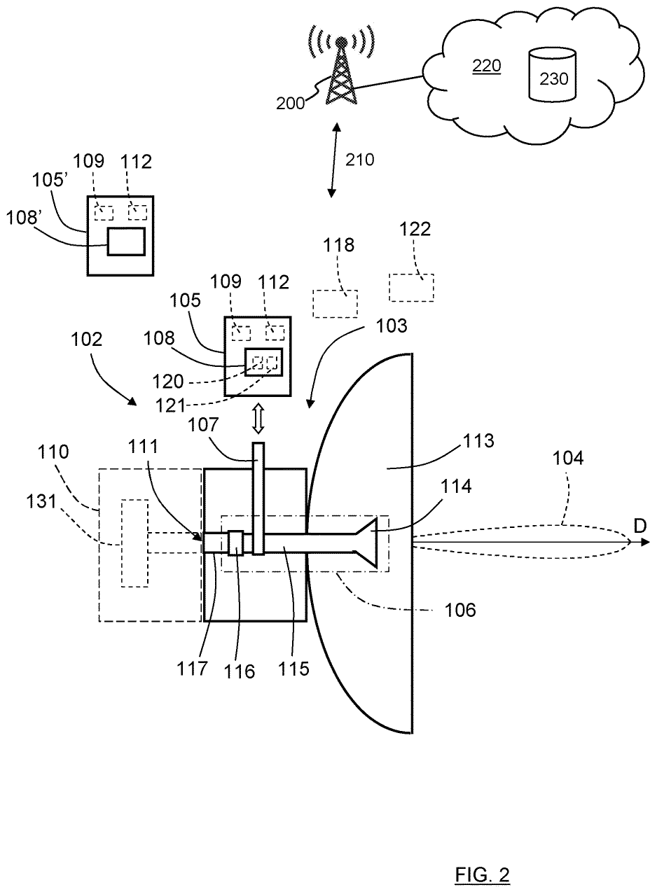

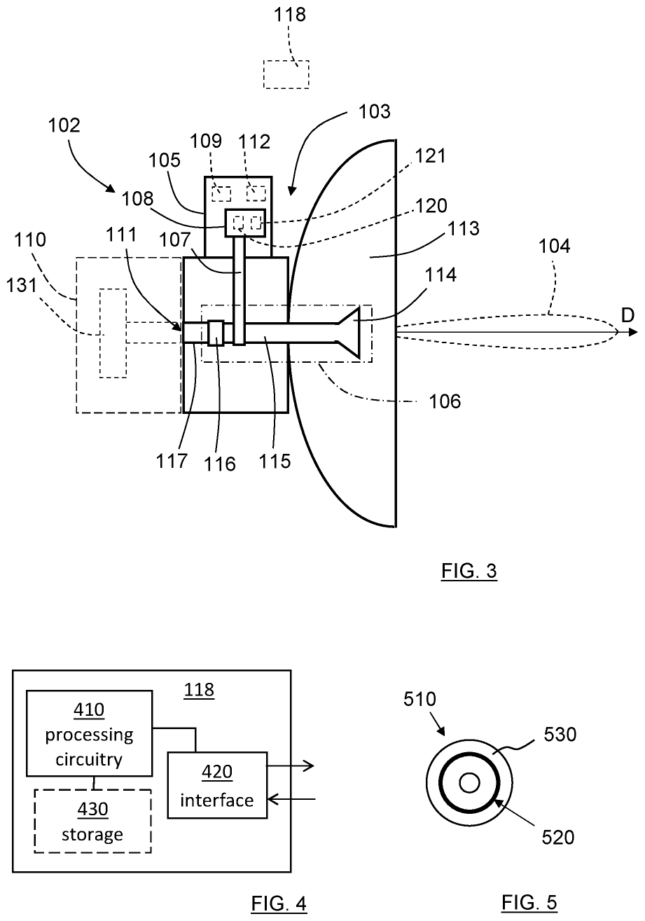

With reference to FIG. 2 and FIG. 3, there is an antenna arrangement 102 comprising an antenna device 103 adapted for a main beam 104, and a control arrangement 105, where the control arrangement 105 is releasably attachable to the antenna device 103. In FIG. 2, two different types of control arrangements 105, 105′ are indicated, which will be discussed more in detail later.

The antenna device 103 comprises steering means 106 for steering a pointing direction D of the main beam 104, and operating means 107 adapted to operate the steering means 106, and the control arrangement 105 comprises a control assembly 108 adapted to engage the operating means 107 when the control arrangement 105 is attached to the antenna device 103. In this way, the control assembly 108 is enabled to control the steering means 106 via the operating means 107. The steering means 106 can be devised in many different ways, some non-limiting examples will be provided.

This means that a releasably attachable control arrangement 105 is used to control the steering means 106, such that the control arrangement 105 only is attached when needed. This provides versatility and the possibility to choose if the antenna device 103 should be steerable or not. This provides easily upgradable functionality where beamsteering antennas can be made in high volume, which reduces the cost per unit. This is enables since the beamsteering functionality is in the removeable and exchangeable control arrangement that easily can be replaced by a newer or upgraded unit, without having to replace the entire antenna.

The reconfigurable antenna device 103 has radiation pattern characteristics, e.g. main beam direction, control of side lobes and nulls, antenna gain, that can be reconfigured or set by mechanically manipulating a part of the antenna device 103, schematically indicated as a steering means 106.

This steering means 106 determines all possible radiation pattern states that the antenna device 103 can have. According to some aspects, the variation of the radiation pattern can be in one dimension, for example only vertical or horizontal steering, or two dimensions, vertical and horizontal.

Some embodiments of a reconfigurable antenna device 103 include:
A single reflector system where the reconfiguration of the pattern is realized by a reflector feed, for example a hat feed, that is titled by a waveguide joint.
A single or double reflector system where the reconfiguration of the pattern is realized by a laterally moveable feed antenna.
A single or double reflector system where the reconfiguration of the pattern is realized by a moveable (sub-)reflector.

These are all well-known in the art and will not be discussed further.

The antenna device 103 could also have an internal mechanism that sets the reconfigurable antenna unit in a default state, e.g. main beam pointing direction D at 0° azimuth and 0° elevation angle, for example achieved by a spring system that pushes the beamsteering mechanism into the default configuration when no external force is applied or in the absence of the control arrangement 105.

In another embodiment, the antenna unit has an internal mechanism that allows the antenna unit to be fixed in any state without the need if a control unit. For example, a screw that can be tightened so that the beamsteering mechanism cannot be moved anymore.

According to some aspects, the reconfigurable antenna device 103 is a passive device that has no active electronics such as sensors, microcontrollers, power supply unit, etc.

In yet another embodiment, the steering means 106 of the reconfigurable antenna device 103 can be replaceable to allow for quick repairs and upgrades.

According to some aspects, the control arrangement 105 comprises means 109 adapted to determine movement data. In this way, the control arrangement 105 is adapted to collect data that can be used to determine if beemsteering is needed.

According to some aspects, the means 109 adapted to determine movement data comprises at least one of an accelerometer and a gyroscope. In this way, standard components can be used to collect data related to if beemsteering is needed.

According to some aspects, the control arrangement 105 comprises a communication device 112 that is adapted to communicate the determined data. In this way, the data in questions can communicated to other units.

According to some aspects, the control arrangement is an adjusting control arrangement 105 that comprises an adjusting control assembly 108 that is adapted to inflict controlled movements to the steering means 106 via the operating means 107, where each controlled movement corresponds to a certain pointing direction D such that the pointing direction D is steerable by means of the control assembly 108. This means that the control arrangement 105 actively can change a beam pointing direction by engaging and co-operating with parts 106, 107 comprised in the antenna device 103.

According to some aspects, the adjusting control assembly 108 is adapted to engage the operating means 107 by means of an adjustable mechanical interface 120 that comprises at least one of
a pinion rack
a gear wheel
a push rod
an axis
a threaded rod
a chain
a belt.

There thus exists many ways to provide a suitable adjustable mechanical interface 120 that is adapted to engage the operating means 107, the above alternatives merely constituting some examples. A more detailed example follows below.

According to some aspects, the antenna device 103 comprises a reflector dish 113 and the steering means 106 comprises a reflector feed 114 and a waveguide part 115, connected between the feed and a waveguide joint 116. The operating means 107 is in the form of an operating rod that is mechanically connected to the waveguide part 115, such that the position of the operating rod 107 determines the position of the waveguide part 115 and the reflector feed 114. According to some further aspects, the adjusting control assembly 108 is adapted to move the operating rod 107 such that the reflector feed 114 is moved and the pointing direction D is steered in a desired direction.

This means that the operating rod 107 can be moved my means of the adjusting control assembly 108 such that a beam pointing direction D can be obtained.

According to some aspects, the adjusting control assembly 108 comprises a motor device 121 that is adapted to move the operating rod 107 via the adjustable mechanical interface 120. In this way an automatic steering of the beam pointing direction D is enabled. The motor device 121 can be any type of actuator such as a step motor, an electromagnetic actuator, voice coil, etc. For example, the adjustable mechanical interface 120 can comprise screw threads that are adapted to engage corresponding threads comprised in the operating rod 107 In case there is no motor device, the adjusting control assembly 108 may be adapted to allow manual control of the pointing direction D, e.g. using tuning screws or tuning bolts.

According to some aspects, the motor device 121 is adapted to steer the pointing direction D of the main beam 104 either as a compensation for slow changes due to temperature variations, as compensation for fast changes due to wind and/or vibrations, or as a compensation for an induced permanent misalignment. A permanent misalignment can for example be caused by a storm or temperature-induced material deforming. This means that the present disclosure is applicable for many types of disturbances.

According to some aspects, the antenna arrangement 102 further comprises a control unit 118 that is adapted to control the adjusting control assembly 108. This enables a reliable control of the adjusting control assembly 108. The control unit 118 is indicated separately in FIG. 2 and FIG. 3. This is intended to indicate that the control unit 118 can be implemented in many different manners, for example as a separate part that can be mounted to any part of the antenna arrangement 102 and being adapted to communicate with the communication device 112 in a suitable manner, and being adapted to determine and execute control of the motor device 121 where applicable. The control unit 118 can also be implemented as several separate parts. The control unit 118 may at least partly be implemented in a remote server as indicated below.

The control unit 118 may be arranged to communicate 210 with a cellular communication system 200. This communication system may, e.g., be a third generation partnership program (3GPP) defined access network like the fourth generation (4G) or the fifth generation (5G) access networks. The access network may provide access to remote networks and other resources such as, e.g., the Internet.

It is also appreciated that some processing functions may be performed by resources in a remote network 220, such as a remote server 230. Thus, functions of the control unit 180 may be performed remotely on, e.g., the remote server 230.

According to some aspects, the control unit 118 is adapted to control the adjusting control assembly 108 in dependence of determined movement data and/or determined data related to signal properties such as for example received signal strength, Signal to Interference plus Noise Ratio, SINR, Signal to Noise Ratio, SNR, Mean Square Error, MSE, and throughput, errors such as Bitrate Error, BER and Block Error Rate, BLER. The received signal strength can for example be determined as Received Signal Strength Indicator, RSSI, and/or Received Signal Level, RSL.

This means that the control unit 118 can be adapted to control the adjusting control assembly 108 in dependence of either one of determined movement data and determined data related to received signal properties. The signal properties are according to some aspects provided by a corresponding radio unit 110. In other words, in this case the signal property or signal properties in question are determined by the radio unit 110 and communicated from the radio unit 110 to the control unit 105.

In this context it is important determine whether the signal properties relate to mast sway or other causes. For example, for received signal strength, i.e., fading due to rain lowers the received signal strength but should not be interpreted as mast sway. For the received signal strength as well as other signal properties, a more elaborate analysis must be performed such as, for example, detection of periodic variations with different time scales associated with different types of sway. For example seconds for wind-induced sway, ~24 hours for solar-induced tower bending, infinite for permanent misalignment by e.g. a storm. Details of how this is achieved are not discussed further, many options being readily available and apparent for the skilled person.

This means that, according to some aspects, the control unit 118 is adapted to determine if certain received signal properties relate to mast sway or not by means of analysis of periodic variations of the received signal properties with different time scales associated with different types of sway.

According to some aspects, the control arrangement is a fixed control arrangement 105′ that comprises a fixed control assembly 108′ adapted to engage the operating means 107 by means of a fixed mechanical interface that is adapted to control the steering means 106 to assume and maintain a fixed pointing direction D of the main beam 104.

This means that the control arrangement 105′ is adapted to engage the operating means 107 in such a way that the steering means 106 sets and maintains a certain fixed pointing direction D. This can for example be suitable as a first step, during an initial deployment of the antenna arrangement 102. In case the fixed control arrangement 105′ comprises means 109 adapted to determine movement data, and/or in case determined data related to received signal strength can be used to determine if the pointing direction D needs to be adjusted, it is possible to replace the fixed control arrangement 105′ with the adjusting control arrangement 105 as indicated in FIG. 2.

This means that it first can be evaluated whether the more complex adjusting control arrangement 105 is required, or if the control arrangement 105′ is sufficient. If it is determined that the adjusting control arrangement 105 is required, it can even be determined with which type of adjusting control arrangement 105 that should be used to replace the fixed control arrangement 105′, for example an adjusting control arrangement 105 with manually operated beemsteering, or with automatic beamsteering. In the latter case, it can be determined if the replacing adjusting control arrangement 105 should be adapted for rapid or slow changes of the beam pointing direction D, and for periodic or non-periodic changes of the beam pointing direction D. There can thus be several types of control arrangements 105, 105′, depending on need and cost.

The present disclosure relates to a steerable antenna arrangement 102 that according to some aspects can be upgraded.

According to some aspects, the antenna arrangement 102 comprises two parts or units, with very distinct functionality each, that when combined determine the overall beamsteering functionality of the antenna. The antenna device 103 provides the functionality of reconfiguring the radiation characteristics, primarily the beam pointing direction D. The actual beamsteering control, in which pointing direction D the main beam is directed, how fast it can move, and the control strategy, is handled by the control arrangement 105. There is a well-defined interface between the antenna device 103 and the control arrangement 105 that allows the two units to be separated and recombined.

Since the functionality of the antenna arrangement 102 is determined by the control arrangement 105, several variants of the entire antenna arrangement 102 can be realized by combing the reconfigurable antenna device 103 with different variants of the control arrangement 105 which have different functionality and complexity. In case the reconfigurable antenna device 103 and the control arrangement 105 can be separated and recombined, it is possible to upgrade the antenna arrangement 102 in the field by swapping out the control arrangement 105 in the field for a different control arrangement 105 depending on the needs at that time.

According to some aspects, the control arrangement 105 determines the dynamic performance of the antenna arrangement 102, which radiation pattern state is set, how fast the antenna arrangement 102 can change between states, and which inputs, e.g. sensor data, which is used for these actions.

The complexity, and cost of the control arrangement 105, 105′ is different for different variants and depends on the desired beamsteering functionality. According to some aspects, the control arrangement 105 can be designed such that it:
Fixes the steering means 106 to a fixed position static beam direction, being a fixed control arrangement 105′.
Fixes the steering means 106 to a fixed position and is also equipped with sensors 109 adapted to gather data to identify if the antenna arrangement 102 should be updated with beamsteering capabilities, and if so, of what type, being a fixed control arrangement 105′.
Allows for manual manipulation of the beam pointing direction D, for example during installation, being an adjusting control arrangement 105.
Has the ability to change the beam pointing direction D dynamically. For example, to keep the beam pointing direction D fixed when the antenna device 103, or its mounting structure, is moving, being an adjusting control arrangement 105.

Adjusting control arrangement 105 may also be equipped with sensors 109 adapted to gather data to identify if the antenna arrangement 102 should be updated, and also enabling dynamic control of the pointing direction D.

The control arrangement 105 can according to some aspects be swapped easily to change the functionality of the antenna arrangement 102 as described above The control arrangement 105 can according to some aspects be an “smart device” that contains electronics, sensors, actuators, interface to the radio, etc.

The control arrangement 105 can according to some aspects comprise at least some of the following functional parts. It is to be noted that the control arrangement 105 does not need to have all the different part for it to fulfill a certain functionality.
An interface to the reconfigurable antenna device 103 through which the state of the beamsteering mechanism, the steering means 106, can be manipulated, and doing so changes the state and radiation pattern of the reconfigurable antenna unit 103. In the examples there is an adjustable mechanical interface 120.
A way to manipulate the interface 120, for examples actuators to make it move such as the motor device 121 in the examples. This can also be a mechanism that allows manual manipulation by a field operator, for example, by turning a screw the interface 120 is moved.
Sensors 109 to monitor movements and/or angular tilt.
A communication interface to the radio unit 110 and/or the control unit 118, through which data can be transferred in both ways. For example: sensor data, RSSI, motion sensor data, control setting, performance metrics, etc. This can for example be comprised in the communication device 112.
A power supply that either is external or internal.
An operator interface 122 to a human operator which enables an operator or installer to directly control and check the status of the antenna arrangement 102. This could be to aid the operator during installation or (re)alignment. Examples of such an operator interface 122 are an audio signal, LED indicator(s), a display, a wired (e.g. USB) or wireless connection to an external device such as for example a smartphone, and one or more buttons. The operator interface is indicated as separate unit in FIG. 2 since it for example can be comprised not only in the control arrangement 105, but also in the antenna device 103 or the radio unit 110.
A computational unit (e.g. microcontroller) that processes the sensor data, determines the state of the antenna, sets the control strategy, controls the different interfaces. In the examples discussed such a computational unit is constituted by the control unit 118.

Some of the required hardware for these parts can be in the control arrangement 105 and can be software activated. Below are some non-limiting examples of embodiments of control arrangement 105 that have different functionality:
A static control arrangement, such as the fixed control arrangement 105′ described above, which consists of a mechanical part that is adapted to engage the operating means 107 such that the pointing direction D is set to a fixed position, for example, azimuth 0° and elevation 0°.
The fixed control arrangement 105′ further comprising one or more sensors 109 and a communication interface such as the communication means 112. The sensors 109 are used to monitor the movement of the antenna device 103, which is reported to the control unit 118. This control arrangement 105′ can be used by an operator if it is uncertain whether a certain site requires beamsteering capabilities or not. The sensor data can be used to guide this decision and can later easily upgrade the control arrangement 105′ to an adjusting control arrangement 105, possibly with dynamic steering capabilities if necessary.
An adjusting control arrangement 105 according to the above, according to some aspects containing all functionality that is required for dynamic beamsteering. Sensors 109 to detect movement, a control unit 118 that processes acquired sensor data and computes a required compensation. Actuators such as the motor device 112 that are used to change the pointing direction D by means an interface between reconfigurable antenna device 103 and the control arrangement 105. This type of control arrangement 105 can have an interface to the radio unit 110 such that the received signal can be used for compensation and for control.

Both fixed and adjusting control arrangements 105′, 105 can exist in many variants. For example, there can be a slow sway compensation and fast sway compensation variants. The slow sway compensation variant can have slower and more cost-effective motor devices/actuators and sensors, while the fast sway compensation variant has better and faster motor devices/actuators and/or better sensors.

If the reconfigurable antenna unit supports reconfiguration of the antenna pattern in two planes, for example horizontal and vertical, different variants of control unit can exist that support 1D or 2D steering.

According to some aspects, the control arrangement 105 is a dedicated control arrangement 105 that is used only during initial alignment. Such a control arrangement 105 can have an interface to the installer as well. This alignment control arrangement 105 can be used during installation of the antenna only, and once alignment is done, the control arrangement 105 is removed, the pointing direction D locked and a cover plate mounted to cover the operating means 107.

According to some aspects, the antenna device 103 comprises a type identification. This can be useful to determine how to fine tune the antenna device 103, for example if the radiation pattern is known. One example is an RFID (Radio-frequency identification) tag in the antenna device 103 and an RFID reader in the control arrangement 105.

With reference also to FIG. 1, the present disclosure also relates to a radio link node 101A, 101B comprising an antenna arrangement 102; 102A, 102B as described herein and a radio unit 110; 110A, 110B that is connected to the antenna arrangement 102; 102A, 102B via a radio interface 111. The radio interface 111 can for example be a waveguide transition or a coaxial connector. Via the radio interface 111, the antenna arrangement 102 is according to some aspects connected to radio circuitry 131.

The present disclosure also relates to a radio link arrangement 100 comprising at least two radio link nodes 101A, 101B according to the above, where the radio link nodes 101A, 101B are adapted to communicate with each other via a corresponding communication link 119.

According to some aspects, there is an upgradeable high gain steerable antenna arrangement 102 that comprises a reconfigurable antenna device 102 and a control arrangement 105′, 105. The steering and mast sway compensation capabilities of the antenna system can be adapted by using different versions of the control unit. A change of control arrangement 105′, 105 is easily done and can be performed in the field. The functionality, complexity and cost of the control arrangement 105′, 105 can vary significantly depending on the use case. For example the control arrangement can be:
A simple pure mechanical control arrangement sets the beamsteering mechanism to a fixed position. The antenna device 102 has a predefined radiation pattern
A somewhat more complex control arrangement that allows manual control of the beam pointing direction D, e.g. by means of tuning screws.
A control arrangement that sets a beamsteering mechanism such as the steering means 106 described above, to a fixed position and is also equipped with sensors allowing an operator to gather data to identify if the radio link node 101A, 101B in question should be updated with beamsteering capabilities, and if so, of what type; for example being able to compensate for slow mast sway or fast mast sway.
An advanced control arrangement has sensors, actuators, control unit, etc. as described above and can dynamically steer the beam pointing direction D of the antenna device 102, for example to compensate for mast sway.
A less advanced control arrangement with less expensive actuators and control unit that can be operated remotely to realign the antenna, for example after a heavy storm. Misalignment detection will in this case be done by other means.

FIG. 4 schematically illustrates, in terms of a number of functional units, the components of a control unit 118 according to an embodiment of the discussions herein. Processing circuitry 410 is provided using any combination of one or more of a suitable central processing unit CPU, multiprocessor, microcontroller, digital signal processor DSP, etc., capable of executing software instructions stored in a computer program product, e.g. in the form of a storage medium 430. The processing circuitry 410 may further be provided as at least one application specific integrated circuit ASIC, or field programmable gate array FPGA. The processing circuitry thus comprises a plurality of digital logic components.

Particularly, the processing circuitry 410 is configured to cause the control unit 118 to perform a set of operations, or steps. For example, the storage medium 430 may store the set of operations, and the processing circuitry 410 may be configured to retrieve the set of operations from the storage medium 430 to cause the control unit 118 to perform the set of operations. The set of operations may be provided as a set of executable instructions. Thus, the processing circuitry 410 is thereby arranged to execute methods as herein disclosed.

The storage medium 430 may also comprise persistent storage, which, for example, can be any single one or combination of magnetic memory, optical memory, solid state memory or even remotely mounted memory.

The control unit 118 further comprises an interface 420 for communication with at least one external device, such as sensors 109, the radio unit 110 and the motor device 112. As such the interface 420 may comprise one or more transmitters and receivers, comprising analogue and digital components and a suitable number of ports for wireline communication.

The processing circuitry 410 controls the general operation of the control unit 118, e.g. by sending data and control signals to the interface 420 and the storage medium 430, by receiving data and reports from the interface 420, and by retrieving data and instructions from the storage medium 430. Other components, as well as the related functionality, of the control node are omitted in order not to obscure the concepts presented herein.

FIG. 5 shows a computer program product 510 comprising computer executable instructions 520 arranged on a computer readable medium 530 to execute any of the methods disclosed herein.

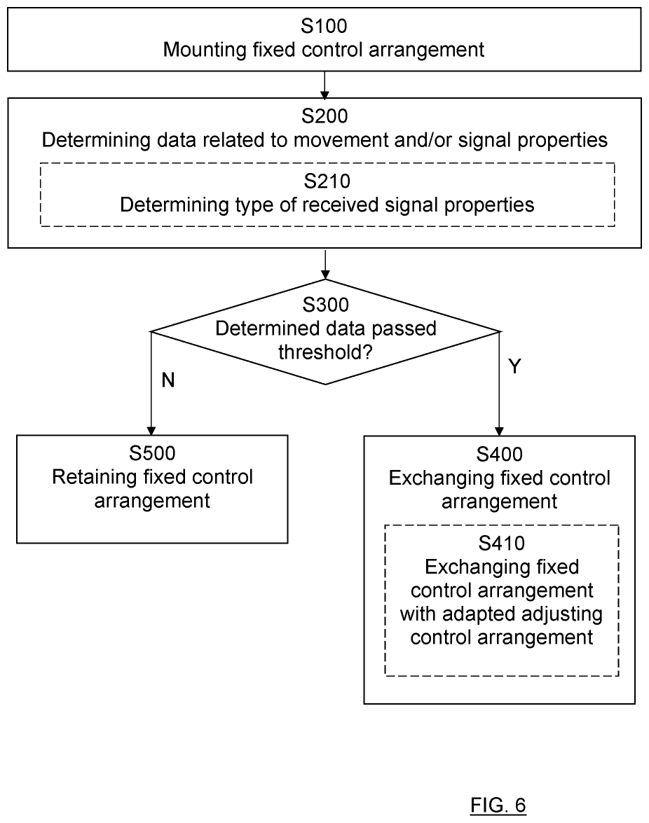

With reference to FIG. 1-FIG. 3 and FIG. 6, the present disclosure also relates to a method for a radio link node 101A, 101B. The method comprises mounting S100 a fixed control arrangement 105′ as described herein and determining S200 data related to radio link node 101A, 101B movement and/or data related to properties for a signal received at the radio link node 101A, 101B, received signal properties, including at least one of received signal strength, Signal to Interference plus Noise Ratio, SINR, Signal to Noise Ratio, SNR, Mean Square Error, MSE, and throughput, errors including at least on of Bitrate Error, BER and Block Error Rate, BLER. If S300 determined data passes at least one predetermined threshold, the method comprises exchanging S400 the fixed control arrangement 105′ with an adjusting control arrangement 105 as described herein, otherwise retaining S500 the fixed control arrangement 105′.

According to some aspects, the method comprises determining S210 if certain received signal properties relate to mast sway or not by analyzing periodic variations of the received signal properties with different time scales associated with different types of sway.

According to some aspects, exchanging S400 the fixed control arrangement 105′ comprises exchanging S410 the fixed control arrangement 105′ with an adjusting control arrangement 105 that is adapted for the determined data.

The present disclosure is not limited to the above, but may vary freely within the scope of the appended claims. For example, each one of the point-to-point radio links can be any form of point-to-point radio links such as for example microwave links.

According to some aspects, a point-to-point radio link may be comprised in a point-to-point radio link network that in turn can comprise more than one point-to-point radio link, and thus more than two point-to-point radio link transceivers.

1. An antenna arrangement comprising:
an antenna device adapted for a main beam; and
a control arrangement, wherein
the control arrangement is releasably attachable to the antenna device,
the antenna device comprises:
steering means for steering a pointing direction of the main beam; and
operating means adapted to operate the steering means, and
the control arrangement comprises a control assembly adapted to engage the operating means when the control arrangement is attached to the antenna device, such that the control assembly is enabled to control the steering means via the operating means.

2. The antenna arrangement of claim 1, wherein the control arrangement comprises means adapted to determine movement data.

3. The antenna arrangement of claim 2, wherein the means adapted to determine movement data comprises at least one of an accelerometer and a gyroscope.

4. The antenna arrangement of claim 2, wherein the control arrangement comprises a communication device that is adapted to communicate the determined movement data.

5. The antenna arrangement of claim 1, wherein the control arrangement is an adjusting control arrangement that comprises an adjusting control assembly that is adapted to inflict controlled movements to the steering means via the operating means, where each controlled movement corresponds to a certain pointing direction such that the pointing direction is steerable by means of the control assembly.

6. The antenna arrangement of claim 5, wherein the adjusting control assembly is adapted to engage the operating means by means of an adjustable mechanical interface that comprises:
a pinion rack;
a gear wheel;
a push rod;
an axis;
a threaded rod;
a chain; and/or
a belt.

7. The antenna arrangement of claim 5, wherein the antenna device comprises a reflector dish and the steering means comprises a reflector feed and a waveguide part, connected between the feed and a waveguide joint where the operating means is in the form of an operating rod that is mechanically connected to the waveguide part, such that the position of the operating rod determines the position of the waveguide part and the reflector feed.

8. The antenna arrangement of claim 7, wherein the adjusting control assembly is adapted to move the operating rod such that the reflector feed is moved and the pointing direction is steered in a desired direction.

9. The antenna arrangement of claim 7, wherein the adjusting control assembly comprises a motor device that is adapted to move the operating rod via the adjustable mechanical interface.

10. The antenna arrangement of claim 9, wherein the motor device is adapted to steer the pointing direction of the main beam either as a compensation for slow changes due to temperature variations, as compensation for fast changes due to wind and/or vibrations, or as a compensation for an induced permanent misalignment.

11. The antenna arrangement of claim 1, further comprising a control unit that is adapted to control the adjusting control assembly.

12. The antenna arrangement of claim 11, wherein the control unit is adapted to control the adjusting control assembly in dependence of determined movement data.

13. The antenna arrangement of claim 11, wherein the control unit is adapted to control the adjusting control assembly in dependence of determined properties for a received signal, received signal properties, including at least one of received signal strength, Signal to Interference plus Noise Ratio, SINR, Signal to Noise Ratio, SNR, Mean Square Error, MSE, and throughput, errors including at least on of Bitrate Error, BER and Block Error Rate, BLER.

14. The antenna arrangement of claim 13, wherein the control unit is adapted to determine if certain received signal properties relate to mast sway or not by means of analysis of periodic variations of the received signal properties with different time scales associated with different types of sway.

15. The antenna arrangement of claim 1, wherein the control arrangement is a fixed control arrangement that comprises a fixed control assembly adapted to engage the operating means by means of a fixed mechanical interface that is adapted to control the steering means to assume and maintain a fixed pointing direction of the main beam.

16. The antenna arrangement of claim 1, wherein the antenna device comprises a type identification.

17. A radio link node comprising:
the antenna arrangement of claim 1; and
a radio unit that is connected to the antenna arrangement via a radio interface.

18. A radio link arrangement comprising the radio link node of claim 17 and a second radio link node, where the radio link nodes are adapted to communicate with each other via a corresponding communication link.

19. A method for a radio link node the method comprising:
mounting a fixed control arrangement; and
determining data related to radio link node movement and/or data related to properties for a signal received at the radio link node, received signal properties, including at least one of received signal strength, Signal to Interference plus Noise Ratio, SINR, Signal to Noise Ratio, SNR, Mean Square Error, MSE, and throughput, errors including at least on of Bitrate Error, BER and Block Error Rate, BLER; where,
if determined data passes at least one predetermined threshold, the method further comprises
exchanging (S400) the fixed control arrangement with an adjusting control arrangement, otherwise retaining the fixed control arrangement.

20. The method of claim 19, wherein the method comprises determining (S210) if certain received signal properties relate to mast sway or not by analyzing periodic variations of the received signal properties with different time scales associated with different types of sway.

21. (canceled)
